(19) United States
(12) Patent Application Publication
(10) Pub. No.: US 2020/0034778 A1
(43) Pub. Date: Jan. 30, 2020

(54) ARTIFICIAL INTELLIGENCE SELF-LEARNING TRAINING SYSTEM TO AUTONOMOUSLY APPLY AND EVALUATE AGENT TRAINING IN A CONTACT CENTER

(71) Applicant: Avaya Inc., Santa Clara, CA (US)

(72) Inventors: Dara Geary, Athenry (IE); Enda Dooley, Newcastle (IE)

(21) Appl. No.: 16/043,378

(22) Filed: Jul. 24, 2018

(51) Int. Cl. G06Q 10/06; H04M 3/22; H04M 3/51; G06K 9/62

(52) U.S. Cl. CPC G06Q 10/063114; H04M 3/2227; H04M 2203/403; H04M 3/5175; G06K 9/6262; G06Q 10/06398

(57) ABSTRACT

Providing training interventions in a contact center includes determining a first agent of the contact center to offer training to; selecting from a data store a first training item from among a plurality of training items related to addressing the same training opportunity, each of the plurality of training items having an associated effectiveness value; and assigning the first training item to the first agent. Subsequent to the first agent completing the first training item, an effectiveness of the first training item is measured; and based on the measured effectiveness, the effectiveness value associated with the first training item is adjusted.

### BACKGROUND

The present disclosure relates generally to a contact center environment, and, more particularly, to training agents of a contact center.

Queries to the Contact Center may not always be handled fully by the first agent involved. This can be due to such circumstances as a) the introduction of a new product or service without adequate agent training in advance, b) queries that require specialist or expert-level abilities, c) lack of readily available background information on a particular topic, d) an agent's unfamiliarity with a particular subject matter (for new or inexperienced agents), or e) a general lack of subject matter knowledge (e.g., an under-performing agent). Contacts that are not comprehensively resolved in a timely manner result in poor customer satisfaction, potential negative social media commentary, loss of revenue and require additional resources to follow up and resolve.

### BRIEF SUMMARY

One aspect of the present disclosure relates to a computer-implemented method in a contact center, that includes determining, by a computer of the contact center, a first agent of the contact center to offer training to; selecting from a data store, by the computer of the contact center, a first training item from among a plurality of training items related to addressing a same training opportunity, each of the plurality of training items having an associated effectiveness value; and assigning, by the computer of the contact center, the first training item to the first agent. The method also includes subsequent to the first agent completing the first training item, measuring, by the computer of the contact center, an effectiveness of the first training item; and based on the measured effectiveness, adjusting, by the computer of the contact center, the effectiveness value associated with the first training item.

Another aspect of the present disclosure relates to a system in a contact center that includes a processor programmed to initiate executable operations. In particular, the executable operations include determining a first agent of the contact center to offer training to; selecting from a data store a first training item from among a plurality of training items related to addressing a same training opportunity, each of the plurality of training items having an associated effectiveness value; and assigning the first training item to the first agent. The executable operations also include subsequent to the first agent completing the first training item, measuring an effectiveness of the first training item; and based on the measured effectiveness, adjusting the effectiveness value associated with the first training item.

### BRIEF DESCRIPTION OF THE DRAWINGS

So the manner in which the above recited features of the present disclosure may be understood in detail, a more particular description of embodiments of the present disclosure, briefly summarized above, may be had by reference to embodiments, which are illustrated in the appended drawings. It is to be noted, however, the appended drawings illustrate only typical embodiments encompassed within the scope of the present disclosure, and, therefore, are not to be considered limiting, for the present disclosure may admit to other equally effective embodiments, wherein:

FIG. 1 illustrates a communications system architecture in accordance with the principles of the present disclosure;

FIG. 2 illustrates aspects of a contact center server in accordance with the principles of the present disclosure;

FIG. 3 is a flowchart of an example method of automatically and adaptively providing training in a contact center in accordance with the principles of the present disclosure.

### DETAILED DESCRIPTION

The term “a” or “an” entity refers to one or more of that entity. As such, the terms “a” (or “an”), “one or more,” and “at least one” may be used interchangeably herein. It is also to be noted that the terms “comprising,” “including,” and “having” may be used interchangeably.

The term “automatic” and variations thereof, as used herein, refers to any process or operation done without material human input when the process or operation is performed. However, a process or operation may be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

In the present description, an “agent” and a “resource” can both be used to describe a person working at the contact center handling contacts. A contact center “customer” refers to a company or entity that has products and/or services for which the contact center provides support.

The term “computer-readable medium” as used herein refers to any tangible storage and/or transmission medium that participates in storing and/or providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, RAM, PROM, EPROM, FLASH-EPROM, solid state medium like a memory card, any other memory chip or cartridge, a carrier wave as described hereinafter, or any other medium from which a computer may read. A digital file attachment to email or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

As used herein in connection with embodiments of the present disclosure, the term “contact” refers to a communication from a user or a customer. The communications may be by way of any communications medium such as, but not limited to, a telephone call, email, instant message, web chat, and the like. The terms “user” and “customer” denote a party external to the contact center and are used herein to refer to the other party to a contact or a communications session. A user or customer may include, for example, a person having a commercial relationship with the contact center or with a business represented by the contact center.

For each contact received by the contact center, a computer of the contact center will instantiate a “contact object,” which may comprise one or more variables, functions, and data structures that represent the contact. Each contact object comprises a number of attributes, which are assigned values based on its corresponding contact. Each contact object can also include pointers, links or references to other data and/or attributes associated with its corresponding contact. The contact object may be passed amongst the different queues, databases, systems, software applications and other computer-based resources of the contact center. Each contact object may also include a forward reference to another contact object and a backward reference to yet another contact object. In this manner, a prioritized list, or queue, of contact objects may be constructed.

The terms “determine,” “calculate,” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the present disclosure is described in terms of exemplary embodiments, it should be appreciated those individual aspects of the present disclosure may be separately claimed.

The terms “switch,” “server,” “contact center server,” or “contact center computer server” as used herein should be understood to include a Private Branch Exchange (PBX), an ACD system, an enterprise switch, or other type of telecommunications system switch or server, as well as other types of processor-based communications control devices such as, but not limited to, media servers, computers, adjuncts, and the like. One or more embodiments of the present disclosure may utilize Session Initiation Protocol (SIP) as a communications protocol. SIP is a communications protocol that is known and described in Internet Engineering Task Force (IETF) Request For Comment (RFC) 3261, the content of which is hereby incorporated by reference in its entirety. SIP is an open signaling protocol for establishing many kinds of real-time communications sessions, such as voice, video, and/or instant messaging, and may be used with other IETF protocols to build multimedia architectures including Real-Time Transport Protocol (RTP), Real-Time Streaming Protocol (RTSP), Media Gateway Control Protocol (MEGACO), and the Session Description Protocol (SDP).

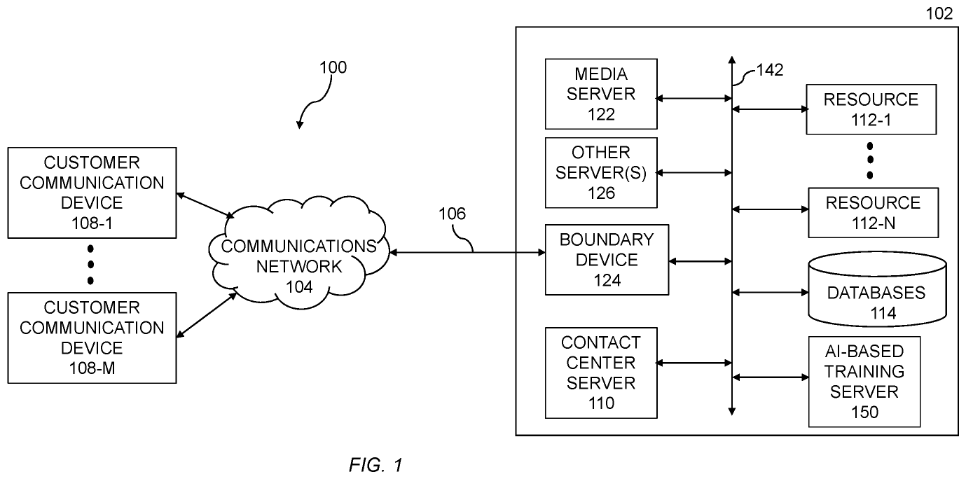

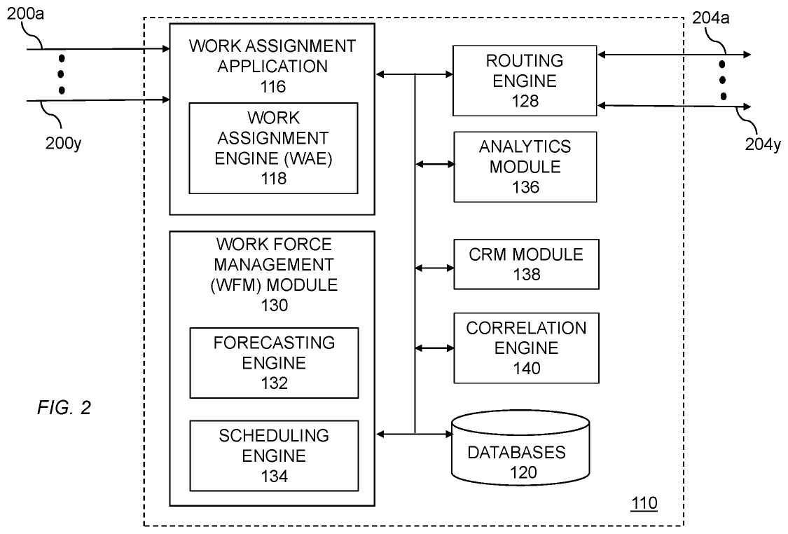

FIG. 1 and FIG. 2 provide an example contact center environment and are provided to illustrate a typical computer-based enterprise architecture in which embodiments in accordance with the present disclosure can be implemented.

FIG. 1 shows an exemplary embodiment of a communications system 100 according to the present disclosure. The communications system 100 may comprise a communications network 104 connecting components of a contact center 102 via a communications link 106 to one or more customer communication devices 108-1 to 108-M, where M is an integer, M≥1 (referred to herein collectively as a customer communication device 108). Each customer communication device 108 may be associated with a contact or customer and may comprise, for example, a cellular phone, computer, Personal Digital Assistant (PDA), digital or analog phone, and the like. The communications network 104 may comprise any type of known communication medium or collection of communication media and may use any type of protocols to transport messages between endpoints. The communications network 104 may be packet-switched and/or circuit-switched and may include wired and/or wireless technologies.

The contact center 102 may comprise, for example, a boundary device 124, a central contact center server 110, a media server 122, one or more other servers 126, and a set of data stores or databases 114. The additional servers 126 may include, for example, an Interactive Response unit (IVR), a voice portal, a video call server, an email server, and the like. Some or all of the components of the contact center 102 may be interconnected by an internal network 142 such as a local area network (LAN) or WAN. One or more of the components of the contact center 102 may also be connected via one or more optional communications links (not shown) to one or more other components of the contact center 102.

Although depicted as separate servers and/or applications that are co-located with one another, it should be appreciated that such a configuration of components is not required. For example, some or all of the functions depicted in FIG. 1 may be co-hosted and/or co-resident on a single server and/or processor, e.g., the contact center server 110, and/or two or more of the contact center 102 components may be distributed and connected to one another over the communication network 104, with the communications between these components may be secured with tunneling protocols or a Virtual Private Network (VPN; not shown). In addition, although one central contact center server 110 is depicted in FIG. 1, two or more servers 110 may be provided in a single contact center 102 or across multiple separate LANs 142 owned and operated by a single enterprise, but separated by the communications network 154. Likewise, two or more media servers 122 may be provided in the contact center 102. In configurations where the contact center 102 includes two or more servers 110 and/or media servers 122, each server 110, 122 may comprise similar functionality, but may be provisioned for providing its features to only a subset of all contact center users.

A customer associated with a customer communication device 108 may utilize the device 108 to generate and transmit a communication, such as a telephone call, an email message, an instant message (IM), an SMS message, etc., over the communications network 104, which is received as a contact at the contact center 102. The contact may be received at the boundary device 124, which maintains a secure separation between the communication network 104 and the internal network 142 and facilitates communications between the customer communication device 108 and the contact center 102. The boundary device 124 may include the functionality of one or more of a switch, a computer-telephony integration (CTI) interface, a SIP gateway, a security gateway, a firewall, a router, or the like. A boundary device 124 comprising a SIP gateway may, for example, connect with one or more SIP trunks from the communications network 104 and split incoming aggregate SIP traffic into individual SIP sessions and aggregate the individual outbound SIP sessions. The boundary device 124 may be implemented as hardware such as via an adjunct processor (as shown) or as a chip in the contact center server 110 (not shown).

Following receipt at the contact center 102, a contact object is instantiated for each contact as described herein and the contact objects are distributed to a plurality of resources 112-1 to 112-N, wherein N is an integer, N≥1 (referred to collectively herein as resource 112). Each resource 112 represents a processing resource of the contact center 102 and may comprise completely automated resources (e.g., processors, servers, or the like), human resources utilizing communication devices (e.g., human agents utilizing a computer, telephone, laptop, etc.), or any other resource known to be used in a contact center 102. In some embodiments, contact objects may be assigned to the IVR (not separately labeled), a voice portal (not separately labeled), or other component of the contact center 102 for automated customer service processing prior to or simultaneous with assigning the contact object to a human resource (e.g., a contact center agent). For example, the voice portal and the IVR may work together to provide IVR services to the contacts.

Each resource 112 may be associated with a resource communication device (not shown), which may be a packet-switched device such as a computer workstation, an IP hardphone or softphone, a packet-based H.320 video phone and conferencing unit, a packet-based voice messaging and response units, a packet-based traditional computer telephony adjunct, a peer-to-peer based communications device, and/or any other suitable communications device. These packet-switched devices may be SIP compatible. The resource communication device may also comprise circuit-switched devices that each correspond to one of a set of internal extensions and may include, for example, wired and wireless telephones, voice messaging and response units, traditional computer telephony adjuncts, and any other suitable communications device.

With reference to FIG. 2, the contact center server 110 may further comprise a work assignment application 116, a routing engine 128, a work force management (WFM) module 130, an analytics module 136, a customer relationship management (CRM) module 138, a correlation engine 140, and one or more database(s) 120. Although each of these functions is depicted in FIG. 2 as residing on the contact center server, it should be appreciated that one or more of the functions, such as the routing engine 128, may reside elsewhere and/or be executed by another server/engine.

Each contact object may comprise one or more work items and generally comprises at least a request for a resource 112. The format of each work item may depend upon the capabilities of the communication device 108 and the format of the communication. In particular, work items are logical representations within the contact center 102 of work to be performed in connection with servicing a particular contact received at the contact center 102 (and more specifically at the work assignment application 116). Work items may be received at the work assignment application 116 from the customer communication devices 108 via one or more customer communications lines or channels 200a to 200y (which may be one or more trunks, phone lines, etc.) and maintained at the work assignment application 116, a switch or server connected to the work assignment application 116, or the like until a resource 112 is assigned to the work item. The work assignment application 116 comprises a work assignment engine 118 that enables the work assignment application 116 to make intelligent routing decisions for work items. As used herein, assignment and/or routing of a contact or contact object to a resource and association of contact attributes with the contact or contact object are intended to be synonymous with assignment and/or routing of the work item(s) associated with the contact or contact object to a resource and association of contact attributes with the work item(s).

The work assignment engine 118 may determine which of the plurality of processing resources 112 is qualified and/or eligible to receive the work item and further determine which of the plurality of processing resources 112 is best suited to handle the processing needs of the work item. In situations of a work item surplus, the work assignment engine 118 may also determine an optimal assignment of a work item resource to a particular resource, e.g., resource 112-1. In some embodiments, the work assignment engine 118 may be configured to achieve true one-to-one matching by utilizing bitmaps/tables and other data structures. Following assignment of the resource 112-1 to a work item, the work assignment application 116 passes the work item to the routing engine 128 to connect the customer communication device 108 that initiated the communication with the assigned resource 112-1 via one of a plurality of resource communications lines 204a to 204y (which may be a voice-and-data transmission line such as a LAN 142 and/or a circuit switched voice line).

The WFM module 130 may be configured to manage the workforce of the contact center 102 (namely the human resources 112). The WFM module 130 may comprise a variety of functionalities, such as a forecasting engine 132 and a scheduling engine 134, that operate together to achieve optimal management of the workforce. The forecasting engine 132 may monitor current work item volume, current resource availability/utilization, past work item volume, past resource availability/utilization, estimated wait times, service levels, and other objectives and provides a forecast or estimate of the work item volume and required staffing levels in the contact center 102 for a desired shift period. For example, the forecasting engine 132 may be configured to monitor one or more Service Level Agreements (SLAs) between the contact center 102 and one or more clients or customers of the contact center 102 to ensure compliance with the applicable SLA(s).

The scheduling engine 134 uses the information provided by the forecasting engine to schedule human agents, e.g., resources 112, to work in the contact center 102. Additionally, the forecasting engine 132 may automatically identify future resource availability issues (in the short-term or long-term) and notify the scheduling engine 134, thereby enabling the scheduling engine 134 to adjust the scheduling of resources 112 as necessary. In some embodiments, the forecasting engine 132 is capable of analyzing prior and current contact center performance to determine if the contact center 102 will require more or less resources 112 at any particular time, e.g., the beginning or end of a calendar month. The scheduling engine 134 may also be configured to monitor schedule adherence, social media activity, and the like, and the WFM module 130 may enable shift bidding, schedule adjustments, work-at-home resource re-scheduling, and the like.

The analytics module 136 may be utilized to track trends and generate one or more reports that indicate agent performance and overall performance of the contact center 102. In some embodiments, the analytics module 136 may be configured to pull data stored in one or more databases 114, 120 and prepare the data in a human-readable format. The database(s) 114, 120 may be configured to store information about any or all components of the contact center 102 such as statistics related to the WFM module 130 (e.g., resource utilization, compliance with SLA agreements, compliance with objectives, etc.), resource performance statistics (e.g., Key Performance Indicators (KPIs)), and statistics related to the WAE 118 (e.g., decisions per time period, successful routing decisions, estimated wait time, etc.). Advantageously, the analytics module 136 may be configured to run one or more reports for predefined data automatically at predefined intervals. The analytics module 136 may also be enabled to run ad-hoc reports based on inputs received from a contact center administrator or manager. Further still, the analytics module 136 may be configured to run reports in response to a predetermined event or series of events occurring in the contact center 102.

The CRM module 138 may be configured to collect and manage historical customer information, current customer information, information related to interactions between a customer and a contact center 102, customer preferences, customer purchase history, customer return history, customer aliases (e.g., in social media networks), and the like. Such information may be stored and maintained in one or more of the database(s) 114, 120. The CRM module 138 may be utilized to help the contact center 102 provide a more robust and personalized customer service experience. In some embodiments, the CRM module 138 may retrieve desired CRM information from the database(s) 114, 120 to enable one of the resources 112 to more efficiently process a work item for a returning or known customer. For example, when a work item is received in a contact center 102 and the work item is associated with a customer having historical information stored as CRM information in one of the databases 114, 120, the CRM module 138 may retrieve some or all of the CRM information and provide the retrieved information to a resource 112, thereby enabling the resource 112 to provide a more personalized service to the customer.

In some embodiments, the contact center server 110 and its various functionalities may be configured to administer and make work assignment decisions in a queueless contact center, as described in U.S. Pat. No. 8,634,543, the entire contents of which is hereby incorporated herein by reference.

In other embodiments, the server 110 may be configured to execute work assignment decisions in a traditional queue-based (or skill-based) contact center, as described in U.S. Pat. No. 8,234,141, the entire contents of which is hereby incorporated herein by reference. Skill-based contact centers may maintain a resource profile, which includes information related to each resource's skills, level(s) of skill expertise, and training, as well as metrics associated with a plurality of work items serviced by the resource for each resource skill (e.g., contact type, duration, and resolution, ratings from the customer and/or a supervisor, etc.). The resource profiles may be stored, for example, in one or more contact center database(s) (e.g., 114, 120 in FIGS. 1 and 2). This resource information is used to assign each resource to one or more skill groups or resource queues (not shown). When a new contact is received at a skill-based contact center, information about the contact is determined, such as the customer's identity and current needs, customer value, and the resource skill that is required for the proper handling of the contact, and this information, along with additional data such as current contact center queue lengths, is used to assign each new contact to a work item queue (not shown). Some of the information related to the one contact may be maintained in a customer profile, which may also be stored, for example, in one or more contact center database(s) (e.g., 114, 120 in FIGS. 1 and 2). Contacts are assigned to resources based on a comparison of the resource skill required to service the contact and the skillset(s) of each resource.

In further embodiments, the server 110 and its various functionalities are configured to execute work assignment decisions in an attribute-based contact center, such as a contact center using the Avaya Oceana™ Solution. Similar to a skill-based contact center, attribute-based contact centers gather information about customers and assign each contact to a resource based on matching between customer and resource data. However, attribute-based matching provides a match based on a plurality of individual attributes of the contact and the resource, as opposed to matching based on a single “skill” assigned to the contact in a traditional skill-based setting. Attribute-based matching provides more details about the contacts and delivers a greater degree of granularity than traditional skill-based matching, which permits more accurate forecasting of future needs.

In an attribute-based contact center, a list of contact attributes is assigned to, or associated with, each incoming contact, in which the attributes describe the optimal resource for handling the contact. The contact attributes may include real-time or current information related to the present communication, such as a type of assistance required (sales, support, etc.), channel type (voice, email, etc.), a current customer mood or behavior (as identified using, for example, detection of certain keywords, repeated clicking or tapping, etc.), and the like. The contact attributes may also include historical or contextual data related to one or more previous communications with the customer, such as a preferred language, a preferred region for resource location, a customer priority, and the like. The contextual data may be combined from multiple communications channels and/or communications sessions and may be stored in the customer profile. Information related to the attributes of each resource (e.g., languages spoken, geographic location, personality type, etc.) may similarly be stored in a resource profile. The list of contact attributes is compared to the unique combination of attributes assigned to each resource, and the contact is routed to the most suitable resource based on a matching combination of attributes. Matching based on individual attributes ensures that each incoming contact is assigned to the most suitable resource, thereby improving first call resolution. Attribute-based matching also allows the contact center to more accurately anticipate the volume and type of future incoming contacts and to forecast the required staffing levels.

In a contact center environment, one mechanism to improve the general competence of an agent pool is to assign agents training to improve performance in specific areas. There can be a monetary cost associated with such training, so, from a contact center Administrator's perspective, it is important to know what training works and what does not. Companies benefit when they have a way of a) quickly identifying that a knowledge gap exists, b) supplying the required training to the delinquent agent(s) and c) evaluating the effectiveness of that training to determine what methods perform best and drive the best results. Conventional practice is typically to assign training to groups of agents on a largely ad-hoc basis.

There is a lack of autonomous response to different levels of agent performance when handling the same types of contacts. Existing contact center solutions lack a learning method to detect problem areas and to proactively offer solutions, both pre-configured and self-adapting.

In general, embodiments in accordance with the present disclosure relate to an artificial intelligence (AI) system that i) monitors contact center activity; ii) identifies knowledge or competence gaps using a range of triggers; iii) selects a training method from a database of training items; iv) automatically schedules and assigns that training; v) subsequently evaluates the effectiveness of that training; and vi) promotes or eliminates that training item or method based on its effectiveness.

The presently described AI system may improve agent expertise and hence customer service by detecting when factors negatively impacting a metric of interest to a contact center's customer (e.g., First Call Resolution) arise and then providing solutions. The system monitors and learns which agents regularly need help with which topics; it then arranges for up-skilling opportunities to improve their expertise; and then rates and adjusts the training based on the performance of the agents post-training.

The introduction of a new product (e.g., new tablet) or new product line (e.g., drones) is often accompanied by a steep learning curve in terms of bridging agents' knowledge gap. In accordance with embodiments of this disclosure, an AI system includes a mechanism to optimize the effectiveness of contact center training. In particular, the system can continue to monitor a problematic scenario after the application of a training solution, determine if the situation has been satisfactorily resolved, and then use this feed-back into the selection of training for the next group of underperforming agents.

Included in the system is the use of machine-learned classification; which can make a determination that an agent with characteristics A, B and C would benefit from one type of training while a different agent having characteristics X, Y and Z would benefit from a different training offer. ‘Characteristics’ in this instance can refer to attributes, skill-sets, properties, proficiencies or any other suitable valuation regarding an agent.

In FIG. 1, an AI-based training server 150 is shown within the contact center environment as a single functional block; however, one of ordinary skill will recognize that the functions of the training server 150 described herein may be distributed across different systems, software, and modules within the contact center. The training server 150 is in communication with the other devices and databases within the contact center and, thus, can send and receive information about a) an agent handling a contact, b) a contact object representative of that contact interaction, c) an agent's performance, d) activity of the agent (e.g., texting, adding a voice call, etc.), e) work schedules of contact center resources, and f) activity of a supervisor or other agent with respect to the contact interaction. The training server 150 can also communicate with databases (e.g., 114, 120) of the contact center to store and retrieve training material, store and retrieve information about training opportunities, store and retrieve information about the effectiveness of a training item or material, or store and retrieve information about agent characteristics as they pertain to training items and materials.

As explained in more detail below, the training server 150 can monitor contact center activity or access data about contact center activity collected by other servers and systems of the contact center. The training server 150 can utilize a first AI component to recognize a pattern of activity that likely indicates an agent in need of training. This AI component can, for example, be a rule-based system that detects events matching a predefined rule as a way to identify a training need.

The training server 150 can then select from a database (e.g., 114, 120) a training item to provide as a way to address the identified training need. The training item can be one tailored to a particular topic for which the agent has a knowledge gap and can also be tailored based on the activity of the agent. For example, a first training item selected for an agent that routinely conferences-in their supervisor on call may be different than a second training item selected for an agent that routinely tells a contact that “I'm sorry, I do not know the answer to that question” and sets a Disposition on the contact for a call-back once the answer has been determined. The selected training item may also be tailored to characteristics about the agent such as their skill-set or previous training.

Because the training server 150 has access to information about the work schedule of an agent and their current activity, the training server 150 can automatically schedule when the selected training item is offered to the agent. The training opportunity may be offered during the ongoing contact, immediately after the contact is handled, or sometime in the future. Because the training server 150 knows the schedule information about the training, the training server 150 can determine when the training item should be completed. Alternatively, an acknowledgement can be explicitly generated by the agent or some other automated system and sent to the training server 150 as an indicator that the training has been completed.

The training server 150 can then analyze information about the agent's performance in the time period after the training item has been completed. A second AI component of the training server 150 can then determine to what extent the agent's performance has improved and use that as a measure of the effectiveness of that particular training. One of ordinary skill will recognize that there are known methods of statistical analysis to analyze the data before training and the data after training that is collected for multiple agents in order to determine relative effectiveness levels of different training items. Based on the effectiveness of a training item it can be promoted or eliminated as the training item the training server 150 will select in the future when a new need for training is identified. Applicable measures of effectiveness other than merely an agent's performance may be used. Including, for example, a change in the dollar values of subsequent calls, the amount of repeat business, the average revenue when that agent is logged in, etc. In other words, effectiveness measures are not necessarily restricted to conventional contact center metrics alone, but any other measure that is useful to a business.

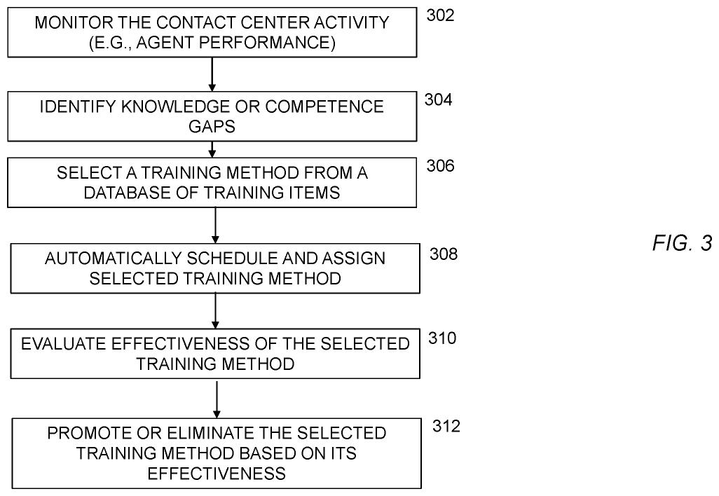

FIG. 3 is a flowchart of an example method of automatically and adaptively providing training in accordance with the principles of the present invention. Automatically identifying performance gaps as they are occurring and then adaptively selecting effective training solutions allows for more efficient operation of the computer resources utilized by the contact center and may thereby reduce the amount of computer resources the contact center operates and maintains.

As an initial matter, in step 302, the performance of the agents of the contact center is monitored to identify, in step 304, a training need. This monitoring may preferably be performed in near real-time as the agent is handling a contact to detect a “trigger” which identifies a training need. In some instances, the trigger is identifiable only after a contact has been handled and, furthermore, the monitoring could be performed by analyzing an agent's performance at the end of a day or the end of a shift.

One example trigger can be an agent consulting other agents. The consulting can be a formal consultation/conference (i.e., the agent announces that they need to consult with someone so that the contact is aware of the conference). However, the consulting can also be as a peer-to-peer Instant Message (IM) or other messaging session (which happens during the interaction but which the contact will not see) or the agent can make an outgoing call while handling a non-voice contact (e.g., chat or email).

Other example triggers can include: a) an agent calling or messaging his/her supervisor; b) a supervisor ‘coaching’ an agent in dealing with a problematic subject; c) a supervisor ‘barging in’ on an agent to take over and resolve an on-going interaction; d) an agent flagging a contact for ‘follow up’ to, e.g., call back with the requested piece of information; e) a contact requesting an escalation (e.g., ‘may I speak with your supervisor’?); f) one or more agents transferring a contact to another agent; or g) the presence of certain phrases or words detected based on keyword analysis (spoken or textual) of an interaction (e.g., ‘I'm not sure’, ‘Let me look that up for you’, etc.).

Some of these triggers by themselves may not necessarily always identify when training is needed. Thus, embodiments in accordance with the present disclosure can autonomously apply one or more rules to help identify when a training need exists.

One of the characteristics of a contact or interaction that the contact center tracks is the “topic” or “subject” of the contact. Thus, the number of triggers that occur for an agent when addressing a particular topic can be tracked by the present system. If that number exceeds a predetermined threshold, then the system can determine that the agent needs additional training on that topic. One example could be an agent regularly consulting with other agents regarding farm insurance, or regularly having to be coached on this topic. The threshold could apply to a running total of such triggers for an agent or apply to a certain period of time (e.g., 3 triggers on a topic per shift).

Regardless of the topic, the occurrence of a relatively large number of triggers for a particular agent (e.g., as compared with other agents) may indicate general poor performance by the agent. For example, an agent that continually messages his or her supervisor may benefit from additional training.

Another instance in which a need for additional training can be detected is the presence of one or more other agents that are highly proficient expert agents. The system can detect this, for example, by determining that Agents A and B regularly (i.e., some amount above a predetermined threshold) delegate contact calls of a particular topic or difficulty level to Agent C if she is in the office, as she is seen as the ‘expert’. Agents A and B may benefit from additional training.

The number of contacts handled in a particular period of time can be indicative of an agent's knowledge gap. If the agent's answer rate is larger than what is expected for their proficiency level, then this may indicate the agent may be under pressure to simply get through a lot of contacts, without an emphasis on working issues to completion. Thus, the agent may benefit from additional training to address those type of work habits.

Another example way to determine a training need is by performing a post-call survey or other feedback method with the contact. If the contact indicates unhappiness with how interaction was handled, then additional training may be needed.

Once the system identifies the need for training then the system can autonomously act to address that need. As mentioned earlier a database of training items/methods/materials is available for the system to select from, in step 306. In some instances, the same general training content may be in each item but the different items may be different media (e.g., text vs. audio vs. video). In other instances, the content may be different (as well as the media) such as a short cheat-sheet versus a three-day off-site seminar. As described below, the present system monitors effectiveness of different training items as a way to eliminate or promote an item based on its effectiveness. Thus, for a given training need that has been identified, the system can select a particular training item, from a plurality of training items, based on its effectiveness. If not enough data is available yet to have statistical confidence that one training item is more effective than another for a particular training opportunity, then the system can randomly select between different training choices in order to generate evidence of a training item's effectiveness relative to another's.

The system can then, in step 308, automatically schedule the selected training item/method/material. For example, the system can push or schedule training material to/for the agent. The training material may be any type of training material developed for, or by, the contact center. Example training material could include specifications, datasheets, diagrams or any other content that may be relevant in assisting an agent with resolving queries for a particular topic. For shorter material, it could be presented as a ‘cheat sheet’ that an agent would review and close off with a disposition code, similar to how any other contact is handled by the agent and tracked by the contact center. Alternatively, the training material may include taking an afternoon off to take an online training course; or several days off to take an off-site training course from a third party.

Another example of training material could include the key points from a consultation or coaching session with a supervisor or other agent which are assembled into a package of training material and pushed to the agent similar to how a supervisor can ‘barge in’ to a contact. So instead of pre-prepared material, the content would be tailored to the exact query of the ongoing contact, and made available to all agents as ad-hoc ‘on the job’ training. The system could integrate the training material into the ‘wrap-up’ period following a contact interaction, presenting the learnings in a timely way when the issue is fresh in the agent's mind.

One of ordinary skill will recognize that there are many training methods that can be provided. For example, online training using video conferencing; web-based training courses without a human presenter, face-to-face training where an expert is present in person, etc. The media used is also one differentiating aspect—mainly text based courses versus an audio ‘podcast’ versus a full audio/video experience.

Once the training has been taken, and the agent or agents have returned to their normal duties, the system would continue, in step 310, to monitor and analyze the triggers and rules noted above, searching for improvements in terms of agent behavior and customer satisfaction ratings. In other words, the artificial intelligence-based system includes re-monitoring agent performance post training with a view to choosing best practice training for other agents with a similar problem in the future. As mentioned, effectiveness can be determined based on one or more of a reduction in “triggers”, an improvement in an agent's performance indicators, or an improvement in customer satisfaction with an agent. The system may, for example, monitor and analyze which training material worked and ultimately improved customer satisfaction (or other contact center Key Performance Indicators (KPIs)), closing the feedback loop. For example, the percentage by which one training item reduces “triggers” as compared to a different training item can be used to determine the relative effectiveness of those two training items. A numerical increase in feedback survey values can be used as well with a larger increase being indicative of greater effectiveness.

Ultimately, in step 312, the system promotes or eliminates a training item or method based on its effectiveness. Thus, for a particular training need or training opportunity, the database, or data store, of training items can have a plurality of different training items that are intended to address that training need. As the system adaptively learns about the effectiveness of different ones of those training items, the plurality of different training items (that are not eliminated altogether) can have a respective effectiveness value associated with each item to achieve a “ranking” relative to one another. The system can then select, from among the plurality of ranked training items, a training item for a future occurrence of the training need based on which training item is highest ranked. If an agent has already completed the highest-ranked training item and remedial training is still needed, then a next-lowest ranked training item can be offered.

The determination that a particular training item is effective or not effective is not necessarily a binary determination. A first training item may be determined to be more effective than a second training item for agents that have particular attributes or characteristics. However, that second training item may be more effective than the first one for agents that have different characteristics. Thus, even though both training items were determined to be at least partially ineffective for different subsets of agents, the system can retain both training items. The system can further associate with each training item, the characteristics of the agents for which the training was effective. Doing so allows the system to consider both a) the effectiveness of one training item relative to another training item and b) the characteristics of an agent, when determining which training item to offer to an agent when the need for additional training has been identified.

In making the determination about the effectiveness of training items, the system may have access to historical information about what training materials an agent has previously completed. This information may be used by the system to determine if there is an order that training items can be offered to an agent that improves the effectiveness of the latter-offered training. The information could also be used by the system to combine training materials so that training items that were initially separate items are combined and offered together because they have a synergistic effect on effectiveness.

The task of improving agent performance in a typical large (e.g., 20,000 seat) contact center is ideally suited to a machine-based system which can monitor events, gather data and assess outcomes per pre-defined rules at a rate beyond human capability. Such a computer based system would have the capacity in the environment of a contact center to analyze very large amounts of data, identify trends, metrics and outcomes and evaluate effectiveness in a way that would not be practical for a human supervisor for example.

The flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). In addition, while the flowcharts have been discussed and illustrated in relation to a particular sequence of events, it should be appreciated that changes, additions, and omissions to this sequence may occur without materially affecting the operation of the disclosure. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that may contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as JAVA, SCALA, SMALLTALK, EIFFEL, JADE, EMERALD, C++, CII, VB.NET, PYTHON or the like, conventional procedural programming languages, such as the “c” programming language, VISUAL BASIC, FORTRAN 2003, PERL, COBOL 2002, PHP, ABAP, dynamic programming languages such as PYTHON, RUBY, and GROOVY, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks. Alternatively, a symmetric multiprocessor (SMP) system or other configuration including a plurality of processors may be used.

These computer program instructions may also be stored in a computer readable medium that when executed may direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions that execute on the computer or other programmable apparatus provide processes for implementing the functions/acts specified in the flowchart and/or block diagram block or blocks.

While the exemplary embodiments illustrated herein show the various components of the system collocated, certain components of the system may be located remotely, at distant portions of a distributed network, such as a LAN and/or the Internet, or within a dedicated system. Thus, it should be appreciated, that the components of the system may be combined in to one or more devices, such as a switch, server, and/or adjunct, or collocated on a particular node of a distributed network, such as an analog and/or digital telecommunications network, a packet-switch network, or a circuit-switched network. It will be appreciated from the preceding description, and for reasons of computational efficiency, that the components of the system may be arranged at any location within a distributed network of components without affecting the operation of the system. For example, the various components may be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements may be wired or wireless links, or any combination thereof, or any other known or later developed element(s) that is capable of supplying and/or communicating data to and from the connected elements. These wired or wireless links may also be secure links and may be capable of communicating encrypted information. Transmission media used as links, for example, may be any suitable carrier for electrical signals, including coaxial cables, copper wire, and fiber optics, and may take the form of acoustic or light waves, such as those generated during radio-wave and infra-red data communications.

A number of variations and modifications of the disclosure may be used. It would be possible to provide for some features of the disclosure without providing others. For example, in one alternative embodiment, the systems and methods of this disclosure may be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein may be used to implement the various aspects of this disclosure. Exemplary hardware that may be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing may also be constructed to implement the methods described herein.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

While the foregoing is directed to embodiments of the present disclosure, other and further embodiments of the present disclosure may be devised without departing from the basic scope thereof. It is understood that various embodiments described herein may be utilized in combination with any other embodiment described, without departing from the scope contained herein. Further, the foregoing description is not intended to be exhaustive or to limit the present disclosure to the precise form disclosed. Modifications and variations are possible in light of the above teachings or may be acquired from practice of the present disclosure.

What is claimed is:

1. A computer-implemented method in a contact center, comprising:
determining, by a computer of the contact center, a first agent of the contact center to offer training to;
selecting from a data store, by the computer of the contact center, a first training item from among a plurality of training items related to addressing a same training opportunity, each of the plurality of training items having an associated effectiveness value;
assigning, by the computer of the contact center, the first training item to the first agent;
subsequent to the first agent completing the first training item, measuring, by the computer of the contact center, an effectiveness of the first training item; and
based on the measured effectiveness, adjusting, by the computer of the contact center, the effectiveness value associated with the first training item.

2. The computer-implemented method of claim 1, further comprising:
determining, by the computer of the contact center, a second agent of the contact center to offer training related to the same training opportunity; and
selecting from the data store, by the computer of the contact center, a second training item from among the plurality of training items, based at least in part on the adjusted effectiveness value associated with the first training item.

3. The computer-implemented method of claim 1, wherein determining the first agent comprises:
analyzing first behavior of the first agent; and
determining the first behavior matches a predefined pattern indicative of a knowledge or competence gap of the first agent.

4. The computer-implemented method of claim 3; wherein measuring the effectiveness of the first training item comprises:
analyzing second behavior of the first agent; and
determining the effectiveness of the first training item based on a comparison of the first behavior with the second behavior.

5. The computer-implemented method of claim 1, wherein selecting the first training item is at least partly based on the associated effectiveness values of the plurality of training items.

6. The computer-implemented method of claim 5, further comprising:
determining one or more characteristics of the first agent; and
wherein selecting the first training item is at least partly based on the one or more characteristics of the first agent.

7. The computer-implemented method of claim 1, wherein adjusting the effectiveness value associated with the first training item comprises eliminating the first training item from the plurality of training items.

8. The computer-implemented method of claim 1, further comprising:
ranking, by the computer of the contact center, the plurality of training items based on the associated effectiveness values.

9. The computer-implemented method of claim 8, further comprising:
based on the adjusted effectiveness value associated with the first training item re-ranking the plurality of training items by the computer of the contact center.

10. The computer-implemented method of claim 1, further comprising:
pushing, by the computer of the contact center, the first training item to a device associated with the first agent.

11. A system in a contact center, comprising:
a processor programmed to initiate executable operations comprising:
determining a first agent of the contact center to offer training to;
selecting from a data store a first training item from among a plurality of training items related to addressing a same training opportunity, each of the plurality of training items having an associated effectiveness value;
assigning the first training item to the first agent;
subsequent to the first agent completing the first training item, measuring an effectiveness of the first training item; and
based on the measured effectiveness, adjusting the effectiveness value associated with the first training item.

12. The system of claim 11, wherein the processor is programmed to initiate executable operations further comprising:
determining a second agent of the contact center to offer training related to the same training opportunity; and
selecting from the data store a second training item from among the plurality of training items, based at least in part on the adjusted effectiveness value associated with the first training item.

13. The system of claim 11, wherein determining the first agent comprises:
analyzing first behavior of the first agent; and
determining the first behavior matches a predefined pattern indicative of a knowledge or competence gap of the first agent.

14. The system of claim 13; wherein measuring the effectiveness of the first training item comprises:
analyzing second behavior of the first agent; and
determining the effectiveness of the first training item based on a comparison of the first behavior with the second behavior.

15. The system of claim 11, wherein selecting the first training item is at least partly based on the associated effectiveness values of the plurality of training items.

16. The system of claim 15, wherein the processor is programmed to initiate executable operations further comprising:
determining one or more characteristics of the first agent; and
wherein selecting the first training item is at least partly based on the one or more characteristics of the first agent.

17. The system of claim 11, wherein adjusting the effectiveness value associated with the first training item comprises eliminating the first training item from the plurality of training items.

18. The system of claim 11, wherein the processor is programmed to initiate executable operations further comprising:
ranking the plurality of training items based on the associated effectiveness values.

19. The system of claim 18, wherein the processor is programmed to initiate executable operations further comprising:
based on the adjusted effectiveness value associated with the first training item re-ranking the plurality of training items by the computer of the contact center.

20. The system of claim 11, wherein the processor is programmed to initiate executable operations further comprising:
pushing the first training item to a device associated with the first agent.
